(19) United States
(12) Patent Application Publication
(10) Pub. No.: US 2025/0066618 A1
(43) Pub. Date: Feb. 27, 2025

(54) COATING SYSTEMS FOR SILICON-CONTAINING SUBSTRATES

(71) Applicant: Rolls-Royce Corporation, Indianapolis, IN (US)

(72) Inventor: Robert Golden, Indianapolis, IN (US)

(21) Appl. No.: 18/813,730

(22) Filed: Aug. 23, 2024

Related U.S. Application Data
(60) Provisional application No. 63/578,509, filed on Aug. 24, 2023.

(51) Int. Cl. C09D 5/08; C04B 35/80; C04B 41/45; C04B 41/50; C04B 41/52; C04B 41/87; C04B 41/89; C09D 1/00

(52) U.S. Cl. CPC C09D 5/08; C04B 35/80; C04B 41/4552; C04B 41/4558; C04B 41/5024; C04B 41/5071; C04B 41/52; C04B 41/87; C04B 41/89; C09D 1/00

(57) ABSTRACT

An article includes a silicon-containing ceramic substrate and a coating system overlying the silicon-containing ceramic substrate. The coating system includes an intermediate coating overlying the silicon-containing ceramic substrate and a barrier coating overlying the intermediate coating. The intermediate coating includes silicon and hafnium disilicide. A coefficient of thermal expansion of the intermediate coat is less than about 7 parts per million (ppm) per degree Kelvin (K).

This application claims the benefit of U.S. Patent Application No. 63/578,509, entitled “COATING SYSTEMS FOR SILICON-CONTAINING SUBSTRATES” and filed Aug. 24, 2023, the entire contents of which is incorporated herein by reference.

### TECHNICAL FIELD

The disclosure relates to coating systems, and in particular, coating systems used with silicon-containing substrates for high temperature components.

### BACKGROUND

Components of high temperature mechanical systems, such as gas turbine engines, may operate in high temperature, oxidative environments. For example, high-pressure turbine airfoils exposed to hot gases in commercial aeronautical engines typically experience surface temperatures in excess of 1000° C. To maintain integrity in these environments, the components may include a ceramic matrix composite (CMC) substrate covered with one or more coatings to modify conditions at the surface of the substrate. For example, CMC substrates may be coated with a thermal barrier coating to reduce heat transfer from the external environment to the substrate, an environmental barrier coating to reduce exposure of the substrate to oxidative species, such as oxygen, water vapor, or Calcium-Magnesium-Alumino-Silicate (CMAS) containing materials, and/or an abradable coating to improve a seal between the substrate and an adjacent component. Despite the presence of the protective coatings, oxidative species may penetrate the coatings and react with the CMC substrate or other coating overlying the CMC substrate.

### SUMMARY

The disclosure describes example coating systems used with silicon-containing substrates, and techniques and systems for fabricating such coating systems. A silicon-containing ceramic substrate may be susceptible to degradation at high temperatures in an oxidative environment. To protect the substrate, an article includes a coating system overlying the substrate. This coating system includes a barrier coating, such as an environmental barrier coating, that provides chemical, thermal, and/or mechanical protection to the substrate. However, oxidizing agents may still migrate through the barrier coating and react with silicon in the silicon-containing ceramic substrate or silicon-containing bond coat to form a thermally-grown oxide (TGO) layer of silicon dioxide at or near a surface of the substrate or bond coat.

To inhibit the formation of the TGO layer, the coating system includes an intermediate coating, such as a bond coat, between the barrier coating and the silicon-containing ceramic substrate. The intermediate coating includes silicon and hafnium disilicide dispersed in the silicon. Hafnium from the hafnium disilicide diffuses to an interface between the substrate and the barrier coating where the TGO layer may typically form and reacts with silicon dioxide of the TGO layer to consume a portion of the silicon dioxide and form hafnium silicate. The resulting layer of hafnium silicate may be more thermally compatible with the adjacent barrier coating and substrate than the TGO layer, and may be less likely to cause spallation or other damage to the article. To reduce or avoid damage to the coating system caused by thermal expansion differences between layers of the coating system, a coefficient of thermal expansion (CTE) of the intermediate coating is less than about 7 parts per million (ppm) per degree Kelvin (K), which may be relatively similar to the CTE of the adjacent silicon-containing ceramic substrate and barrier coating. In this way, coating systems may inhibit growth of the TGO layer and maintain integrity of the coating system of an article.

In one example, an article includes a silicon-containing ceramic substrate and a coating system overlying the silicon-containing ceramic substrate. The coating system includes an intermediate coating overlying the silicon-containing ceramic substrate and a barrier coating overlying the intermediate coating. The intermediate coating includes silicon and hafnium disilicide. A coefficient of thermal expansion of the intermediate coat is less than about 7 ppm/K.

In another example, a method of forming a coating system includes forming an intermediate coating on a silicon-containing ceramic substrate. The intermediate coat includes silicon and hafnium disilicide. The method further includes either heating the intermediate coating to convert at least a portion of the hafnium disilicide to hafnium dioxide and at least a portion of the silicon to silicon dioxide or depositing an additional intermediate coating that includes hafnium dioxide.

The details of one or more examples are set forth in the accompanying drawings and the description below. Other features, objects, and advantages will be apparent from the description and drawings, and from the claims.

### BRIEF DESCRIPTION OF DRAWINGS

FIG. 1A is a conceptual cross-sectional view of an example article that includes a silicon-containing ceramic substrate and a coating system overlying the silicon-containing ceramic substrate.

FIG. 1B is a conceptual cross-sectional view of a portion of the example article of FIG. 1A after a period of operation.

FIG. 2 is a conceptual cross-sectional view of an example article that includes a coating system on a silicon-containing ceramic substrate that includes a silicon-containing ceramic matrix composite (CMC) substrate.

FIG. 3 is a conceptual cross-sectional view of an example article that includes a coating system on a silicon-containing ceramic substrate that includes a silicon-containing bond coat and a ceramic substrate.

FIG. 4 is a conceptual cross-sectional view of an example article that includes a coating system that includes an abradable coating on a silicon-containing ceramic substrate.

FIG. 5 is a conceptual cross-sectional view of an example article that includes a coating system that includes more than one intermediate layer on a silicon-containing ceramic substrate.

FIG. 6A is a flow diagram illustrating an example technique for forming a coating system on a silicon-containing ceramic substrate that includes heating an intermediate coating.

FIG. 6B is a flow diagram illustrating an example technique for forming a coating system on a silicon-containing ceramic substrate that includes forming two intermediate coatings.

### DETAILED DESCRIPTION

The disclosure describes example coating systems used with silicon-containing substrates, and techniques and systems for fabricating these coating systems. In some examples, a coating system includes a barrier coating formed on a ceramic substrate, such as a ceramic matrix composite (CMC) substrate (e.g., a silicon carbide (SiC)-based CMC substrate) for use in high temperature mechanical systems. Example high temperature mechanical systems may include gas turbines or other thermomechanical systems that produce or operate in high temperature environments.

In the context of gas turbine engines, components that include a ceramic substrate may have a barrier coating that includes an EBC or other barrier coating layers formed on the substrate to provide environmental, thermal, and/or mechanical protection to the substrate during operation of the gas turbine engine in a high temperature environment. For example, the EBC may provide increased protection against oxidizing species, such as oxygen, water vapor, or Calcium-Magnesium-Alumino-Silicate (CMAS). The underlying substrate may be formed from a silicon-containing ceramic material, such as silicon carbide, or may be formed from a ceramic material that includes a silicon-containing bond coat. The silicon of the silicon-containing ceramic substrate may be susceptible to chemical attach at high temperatures.

Despite the presence of the barrier coating, a thermally grown oxide (TGO) layer of silicon dioxide can form on the silicon-containing ceramic substrate over the operational life of the components. The TGO layer may result from the transport of oxidizing species through the coating system, including the barrier coating, to the surface of the substrate. The oxidizing species interacts with silicon in the silicon-containing ceramic substrate to oxidize at least a portion of the silicon and form the silicon dioxide of the TGO layer. After the TGO layer reaches a critical thickness and number of thermal cycles, the silicon dioxide may undergo a phase transformation from an amorphous phase to a crystalline phase and/or from a beta cristobalite phase to an alpha cristobalite phase, resulting in cracking of the TGO layer and spallation of the coating system from the substrate.

According to aspects of the disclosure, a coating system includes an intermediate coating between a barrier coating, such as an EBC, and a silicon-containing ceramic substrate to inhibit formation and/or growth of a TGO layer. The intermediate coating includes hafnium disilicide dispersed in silicon. Hafnium from the hafnium disilicide diffuses to an interface between the barrier coating and the silicon-containing ceramic substrate where the TGO layer would typically form due to reaction of the silicon with the oxidizing species. The hafnium oxidizes to form hafnium dioxide and reacts with silicon dioxide of the TGO layer to form hafnium silicate, thereby reducing a thickness of the TGO layer. In contrast to silicon dioxide of the TGO layer, which has a relatively low coefficient of thermal expansion (CTE) compared to the barrier coating and/or silicon-containing ceramic substrate, the hafnium silicate has a relatively high CTE that is closer to a CTE of the barrier coating, and is less likely to cause cracking than the silicon dioxide of the TGO layer. In this way, coating systems may inhibit growth of the TGO layer and maintain integrity of the coating system of an article.

To form the coating system, the intermediate coating may be deposited onto a surface of the silicon-containing ceramic substrate. The thickness and composition of the intermediate coating may be selected such that an amount of available hafnium is sufficient to inhibit the growth of the TGO layer over the life of the component, while also producing thermal stresses that are sufficiently low to maintain an integrity of the coating system. To reduce or avoid damage to the coating system caused by thermal expansion differences between layers of the coating system, a composition of the intermediate layer is tailored such that the coefficient of thermal expansion (CTE) is less than about 7 parts per million (ppm) per degree Kelvin (K), which may be relatively similar to the CTE of the adjacent silicon-containing ceramic substrate and barrier coating.

To further accelerate formation of the hafnium silicate layer, the intermediate coating may either primed prior to placement of the article into service to be more reactive with oxidizing species or include an additional coating of hafnium dioxide. As one example, the article may be heated to convert at least a portion of the hafnium disilicide to hafnium dioxide and at least a portion of the silicon to silicon dioxide. As another example, the article may include an additional intermediate coating of hafnium dioxide on the intermediate coating of silicon and hafnium disilicide. The available hafnium dioxide may react with silicon dioxide to accelerate formation of the hafnium silicate layer. In these various ways, the intermediate coating may resist spallation of the coating system from the substrate and improve the life of the article.

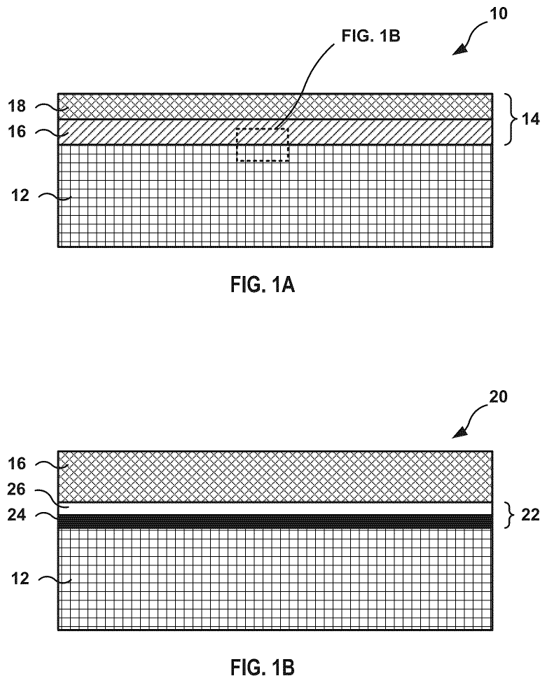

FIG. 1A is a conceptual cross-sectional view of an example article 10 that includes a silicon-containing ceramic substrate 12 and a coating system 14 overlying silicon-containing ceramic substrate 12. Article 10 may be representative of a high-temperature component, such as an industrial, automotive, or aeronautical component. In some examples, the component includes a gas turbine engine component (e.g., a blade, a combustor lining, an airfoil, or a vane). Gas turbine engines may operate at high temperature and in oxidative environments, such that coating system 14 may be particularly suited for protecting a component of a gas turbine engine formed from silicon-containing ceramic substrate 12.

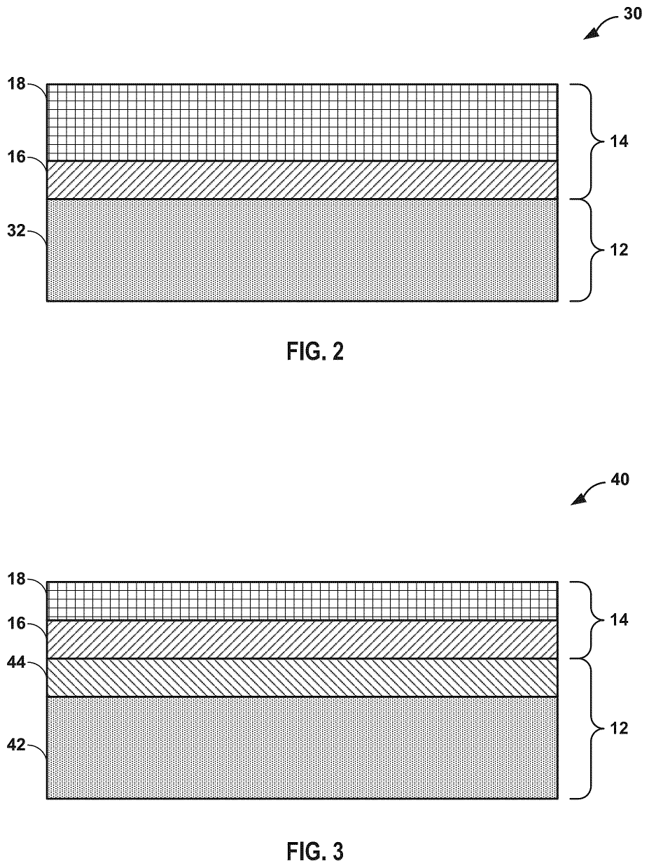

Silicon-containing ceramic substrate 12 includes one or more ceramic materials suitable for use in a high-temperature environment. A ceramic material suitable for use in a high-temperature environment may include any ceramic material, alone or in combination with other materials, that is thermally stable at temperatures greater than about 1000 degrees Celsius (C). Silicon-containing ceramic substrate 12 may include an outer portion that is at least partially composed of silicon. This outer portion of substrate 12 may be the portion near an outer surface of substrate 12 that may be vulnerable to oxidative species that migrate through coating system 14. For example, as will be illustrated in FIGS. 2 and 3 below, substrate 12 may include a ceramic material or composite having at least one material that includes silicon, or may include a ceramic material or composite coated with a layer, such as a bond coat, that includes silicon.

Suitable ceramic materials, may include, for example, a silicon-containing ceramic, such as silica (SiO₂) and/or silicon carbide (SIC); silicon nitride (Si₃N₄); alumina (Al₂O₃); an aluminosilicate; a transition metal carbide (e.g., WC, Mo₂C, TiC); a silicide (e.g., MoSi₂, NbSi₂, TiSi₂); combinations thereof; or the like. In examples in which substrate 12 includes a ceramic material, the ceramic material may be substantially homogeneous.

In some examples, substrate 12 may include a ceramic matrix composite (CMC) material having a matrix material and a reinforcement material. The matrix material may include, for example, silicon metal or a ceramic material, such as silicon carbide (SIC), silicon nitride (Si₃N₄), an aluminosilicate, silica (SiO₂), a transition metal carbide or silicide (e.g., WC, Mo₂C, TiC, MoSi₂, NbSi₂, TiSi₂), or another ceramic material. The composite may further include a continuous or discontinuous reinforcement material. For example, the reinforcement material may include discontinuous whiskers, platelets, fibers, or particulates. Additionally, or alternatively, the reinforcement material may include a continuous monofilament or multifilament two-dimensional or three-dimensional weave, braid, fabric, or the like. In some examples, the reinforcement material may include carbon (C), silicon carbide (SiC), silicon nitride (Si₃N₄), an aluminosilicate, silica (SiO₂), a transition metal carbide or silicide (e.g., WC, Mo₂C, TiC, MoSi₂, NbSi₂, TiSi₂), or the like. The composite of substrate 12 may be manufactured using one or more techniques including, for example, chemical vapor deposition (CVD), chemical vapor infiltration (CVI), polymer impregnation and pyrolysis (PIP), slurry infiltration, melt infiltration (MI), combinations thereof, or other techniques.

Coating system 14 includes a barrier coating 18. Barrier coating 18 may be configured to reduce the migration of oxidative species (e.g., water vapor and/or oxygen) from the outside environment to substrate 12, thereby reducing the formation of a thermally grown oxide (TGO) layer on substrate 12. While illustrated as a single layer, barrier coating 18 may include multiple layers, including different functional layers. In some examples, barrier coating 18 may have a CTE that is relatively close to that of substrate 12, such that barrier coating 18 may better adhere to substrate 12. For example, barrier coating 18 may have a CTE within about 3 parts per million per degree Kelvin (ppm/K) of the CTE of substrate 12.

In some examples, barrier coating 18 includes an environmental barrier coating (EBC). The EBC may include materials that are resistant to oxidation or water vapor attack, and/or provide at least one of water vapor stability, chemical stability, and environmental durability to substrate 12. In some examples, the EBC may be used to protect substrate 12 against oxidation and/or corrosive attacks at high operating temperatures. A primary constituent of the EBC may include at least one of a rare earth (RE) disilicate, a RE monosilicate, a mixture of a RE disilicate and a RE monosilicate (e.g., “silica lean”), a mixture of a RE disilicate and silicon dioxide (e.g., “silica rich”), mullite, or BSAS. For example, a silica-rich disilicate material (also referred to as a hyper-RE disilicate material, such as hyper-ytterbium disilicate) may include excess silica (greater than 67 mol % SiO₂) compared to stoichiometric RE disilicate. The silica-rich RE disilicate may include a single cation RE disilicate (compared to having multiple RE type cations). The RE element in the RE monosilicate and/or RE disilicate may include at least one of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), prascodymium (Pr), cerium (Ce), lanthanum (La), yttrium (Y), or scandium (Sc). In some examples, the EBC may include a multi-RE cation monosilicate composition, e.g., where the monosilicate includes multiple different RE metal cations in its crystal lattice, such as up to three different RE metal cations. Such multi-cation composition, e.g., incorporating multiple different cations into the crystal lattice of the monosilicate phase, may provide for increased ability to tailor properties of the EBC.

In some examples, the EBC includes a dopant in addition to the primary constituents of the EBC. The dopant may be added to the EBC to modify one or more desired properties of the EBC. For example, the dopant may increase or decrease the reaction rate of the EBC with CMAS, may modify the viscosity of the reaction product from the reaction of CMAS and the EBC, may increase adhesion of the EBC to substrate 12, may increase or decrease the chemical stability of the EBC, may increase or decrease the coefficient of thermal expansion (CTE) of the EBC, may act as sintering aids to densify the EBC (e.g., to provide reduced porosity), or the like. In some examples, the dopant includes at least one of Al₂O₃, Fe₂O₃, Fe₃O₄, RE₂O₃, Ta₂O₅, HfO₂, ZrO₂, LiREO₂ and/or RE₃Al₅O₁₂ (e.g., YbAG or YAG). The dopants may be configured to maintain thermal compatibility of the EBC with underlying substrate 12, such that thermally-induced stresses between the EBC and substrate 12 may be substantially low to maintain adhesion of the EBC substrate 12 and/or any adjacent layers. For example, the CTE of the EBC may be maintained less than or equal to about 10 ppm/K to provide a reasonable CTE match to substrate 12, which, for silicon-containing ceramic materials, ceramic composites, and/or bond coats, may have a CTE of less than about 5 ppm/K.

In some examples, barrier coating 18 includes a thermal barrier coating (TBC). The TBC may include at least one of a variety of materials having a relatively low thermal conductivity and may be formed as a porous or a columnar structure in order to further reduce thermal conductivity of the TBC and provide thermal insulation to substrate 12. In some examples, the TBC may include materials such as ceramic, metal, glass, pre-ceramic polymer, or the like. In some examples, the TBC may include silicon carbide, silicon nitride, boron carbide, aluminum oxide, cordierite, molybdenum disilicide, titanium carbide, stabilized zirconia, stabilized hafnia, or the like.

In some examples, barrier coating 18 includes an abradable layer. The abradable layer may include any of the EBC or TBC compositions described herein. The abradable layer may be porous, such that the porosity of the abradable layer may reduce a thermal conductivity of the abradable layer and/or may affect the abradability of the abradable layer. In some examples, the abradable layer includes porosity between about 10 vol. % and about 50 vol. %. In other examples, the abradable layer includes porosity between about 15 vol. % and about 35 vol. %, or about 20 vol. %. Porosity of the abradable layer is defined herein as a volume of pores or voids in the abradable layer divided by a total volume of the abradable layer, including both the volume of material in the abradable layer and the volume of pores or voids in the abradable layer.

Coating system 14 includes an intermediate coating 16 overlying silicon-containing ceramic substrate 12 and underlying barrier coating 18. In the absence of intermediate coating 16, substrate 12 and barrier coating 18 may be subject to damage, such as delamination or spallation, due to formation of a TGO layer between substrate 12 and barrier coating 18. For example, as described above, substrate 12 and barrier coating 18 may have relatively similar coefficients of thermal expansion. Any layers that form substrate 12 and barrier coating 18 which have different coefficients of thermal expansion may create thermally induced stresses in response to thermal cycling events. These stresses may be particularly problematic for components that operate at high temperatures and ambient shutdown conditions, as the change in temperature may be substantial and a higher temperature more conducive for reaction of oxidizing species.

FIG. 1B is a conceptual cross-sectional view of a portion of the example article 10 of FIG. 1A after a period of operation. As illustrated in FIG. 1B, one or more dynamic layers 22 may form between barrier coating 18 and substrate 12 during operation. These dynamic layers 22 may include a hafnium silicate layer 26 and a thermally grown oxide (TGO) layer 24. While illustrated as TGO layer 24 underlying hafnium silicate layer 26, a specific configuration of silicon dioxide of TGO layer 24 and hafnium silicate of hafnium silicate layer 26 may be less defined and/or may have other arrangements.

Without being limited to any particular theory, at high temperatures, silicon, such as silicon in substrate 12 or intermediate coating 16, may react with an oxidizing species to form a TGO layer 24 of silicon dioxide. While TGO layer 24 is illustrated as forming on substrate 12, TGO layer 24 may form on or in any material that includes silicon, such as intermediate coating 16. For example, TGO layer 24 may form between intermediate coating 16 and barrier coating 18 or between substrate 12 and intermediate coating 16.

After prolonged exposure to high temperatures and repeated thermal cycling events, the silicon dioxide of TGO layer 24 may transform from β-cristobalite to a-cristobalite and crystallize. The crystallized silicon dioxide may be brittle and crack in response to thermal events, such as thermal cycling, leading to spallation of barrier coating 18 from substrate 12. To inhibit and/or slow the formation of the crystallized silicon dioxide of TGO layer 24, intermediate coating 16 includes silicon (Si) and hafnium disilicide (HfSi₂). Hafnium from the hafnium disilicide is configured to be incorporated into TGO layer 24 that forms between intermediate coating 16 and the silicon-containing ceramic substrate 12 and react with silicon dioxide of TGO layer 24 to form hafnium silicate and slow formation of TGO layer 24.

Hafnium from the hafnium disilicide migrates to TGO layer 24 that forms between intermediate coating 16 and silicon-containing ceramic substrate 12 and/or between intermediate coating 16 and barrier coating 18. In the presence of an oxidizing agent, the hafnium from the hafnium disilicide oxidizes and forms hafnium dioxide, as illustrated in Equation 1 below:

$$H f {Si}_{2} + {O}_{2} \to H f {O}_{2} + 2 Si \qquad [ Equation l ]$$

Additionally, hafnium dioxide may already be present on a second intermediate coating overlying intermediate coating 16, such as will be described in FIG. 5 below. The hafnium dioxide reacts with silicon dioxide of TGO layer 24 to form a layer of hafnium silicate (“hafnium silicate layer 26”), thereby slowing formation of TGO layer 24, as illustrated in Equation 2 below:

$$H f {O}_{2} + {SiO}_{2} \to H f {SiO}_{4} \qquad [ Equation 2 ]$$

As a result, growth of TGO layer 24 may be slowed and a corresponding thickness of TGO layer 24 limited during the life of article 10. In some instances, growth of TGO layer 24 may be inhibited or limited. For example, TGO layer 24 may form at a similar rate as hafnium silicate layer 26, such that TGO layer 24 may have a relatively constant thickness while sufficient hafnium is available in intermediate layer 16 to form hafnium silicate. In some instances, growth of TGO layer 24 may be slowed. For example, TGO layer 24 may form at a faster rate as hafnium silicate layer 26, such that TGO layer 24 may continue to grow, but at a slower rate than if no hafnium is present in intermediate layer 16.

The life of article 10 may be limited by a thickness of TGO layer 24 that results in spallation of coating system 14 from substrate 12. To inhibit growth of TGO layer 24 for a particular period of time, such as between maintenance or replacement intervals, a composition of intermediate coating 16 may be selected such that a sufficient amount of hafnium is available to form hafnium dioxide and react with silicon dioxide of TGO layer 24 over that desired period of time. A thickness and composition of silicon and hafnium disilicide may be selected to match a growth rate of TGO layer 24 to a diffusion rate of hafnium, oxidation rate of hafnium to hafnia, and reaction rate of hafnia to hafnium silicate so that silicon dioxide forms at a similar rate as hafnium silicate, such that hafnium silicate layer 26 forms instead of TGO layer 24. These various rates may be related to a service profile (time at temperature) for the engine and a hermeticity of barrier coating 18 (related to how fast silicon dioxide forms).

Hafnium disilicide may be present in intermediate coating 16 at an initial concentration and/or volume fraction (e.g., % mol fraction, % vol. fraction, and/or volumetric ratio) so that hafnium is available to form hafnium dioxide for the life of article 10. In some examples, hafnium disilicide is present in intermediate coating 16 at a concentration of about 5% mol fraction to about 25% mol fraction.

In addition to selecting a composition of intermediate coating 16, a thickness of intermediate coating 16 may be selected such that a sufficient amount of hafnium is available to form hafnium dioxide and react with silicon dioxide of TGO layer 24 over the desired period of time. Intermediate coating 16 may be present at an initial thickness so that hafnium is available to form hafnium dioxide for the life of article 10. In some examples, intermediate coating has a thickness between about 25 micrometers and about 300 micrometers.

As mentioned above, differences in CTE of layers formed between barrier coating 18 and substrate 12 may result in thermally induced stresses. To reduce these thermally induced stresses, hafnium silicate layer 26 may have a CTE that is relatively close to a CTE of substrate 12, intermediate coating 16, and barrier coating 18 compared to TGO layer 24. For example, silicon may have a coefficient of thermal expansion of about 3.0 parts per million (ppm) per degree Kelvin (K), such that adjacent layers of article 10, such as substrate 12, hafnium silicate layer 26, intermediate coating 16, and barrier coating 18, may have CTEs that are relatively moderate. As an example comparison, silicon-containing bond coats may have a similar CTE of about 3.0 ppm/K; a silicon-containing ceramic, such as silicon carbide, may have a CTE of about 2.7 ppm/K; and a rare earth monosilicate and/or disilicate EBCs may have a CTE of about 6-9 ppm/K. In contrast, silicon dioxide may have a substantially lower CTE of about 0.56 ppm/K.

To match a CTE of intermediate coating 16 to substrate 12 and/or barrier coating 18, a composition of intermediate layer 16 may be selected such that a coefficient of thermal expansion (CTE) of intermediate coating 16 is less than about 7 parts per million (ppm) per degree Kelvin (K). The composition of intermediate layer 16 may balance a relatively low CTE of silicon with a relatively high CTE of hafnium disilicide. For example, silicon may have a CTE of about 3.0 ppm/K, while hafnium disilicide may have a CTE of about 16.4 ppm/K. As such, a hafnium disilicide may be dispersed in silicon in a volumetric ratio that balances the relatively low CTE of silicon with the relatively high CTE of hafnium disilicide. In some examples, a volumetric ratio of silicon to hafnium disilicide may be between about 3:1 to about 10:1.

In some examples, intermediate coating 16 is compositionally graded, e.g., with varying amounts of hafnium disilicide along the thickness of intermediate coating 16. For example, relatively low amounts of hafnium disilicide may be present at an interface between intermediate coating 16 and substrate 12. The concentration of hafnium disilicide may increase from the interface at substrate 12 to the interface between intermediate coating 16 and barrier coating 18. The hafnium disilicide grading may be selected so there is a good CTE match at the interfaces between intermediate coating 16 and each of substrate 12 and barrier coating 18. In some examples, the hafnium disilicide grading is selected so that there is a higher amount of hafnium for forming hafnium dioxide at the interface between intermediate coating 16 and barrier coating 18. For example, intermediate coating 16 includes a top portion proximate to barrier coating 16 and a bottom portion proximate to silicon-containing ceramic substrate 12, in which a volume fraction of hafnium disilicide in the top portion is greater than a volume fraction of hafnium disilicide in the bottom portion.

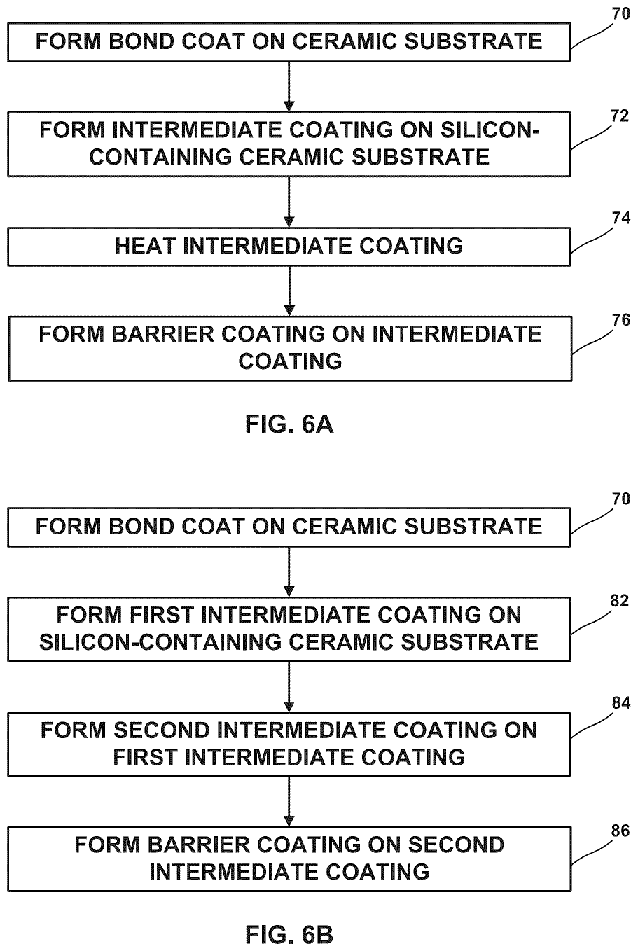

In some examples, intermediate layer 16 further includes hafnium dioxide (HfO₂) and silicon dioxide (SiO₂) dispersed in the silicon. For example, as will be described further in FIG. 6, at least a portion of the hafnium in intermediate coating 16 and at least a portion of the silicon in intermediate coating 16 may be heated and oxidized to form hafnium dioxide and silicon dioxide. Once article 10 is exposed to a high temperature environment, the hafnium dioxide and the silicon dioxide of intermediate coating 16 may react to form hafnium silicate. This formation may accelerate subsequent formation of hafnium silicate, such as by making hafnium dioxide available for reaction with silicon dioxide formed as part of TGO layer 24 and/or diffusion to the reaction interface. As a result, a thickness of TGO layer 24 may be reduced compared to an intermediate coating 16 that does not include hafnium dioxide and silicon dioxide prior to exposing article 10 to a high temperature environment. A concentration of hafnium dioxide in intermediate layer 16 may depend on a variety of factors including, but not limited to, hafnium disilicide in intermediate layer 16, exposure time of intermediate layer 16, exposure temperature of intermediate layer 16, and a composition of oxidizing species in an environment. In some examples, a concentration of hafnium dioxide in intermediate layer 16, prior to entry into operation, is from greater than 0.01% mol fraction to about 50% mol fraction, such as between about 0.1% mol fraction to about 5% mol fraction.

Coating systems described herein may be used with a variety of substrates. In some examples, the coating systems may be used with ceramic or ceramic matrix composite materials that include silicon. FIG. 2 is a conceptual cross-sectional view of an example article 30 that includes an example coating system 14 on silicon-containing ceramic substrate 12 that includes a silicon-containing ceramic matrix composite (CMC) substrate 32. In the example of FIG. 2, intermediate coating 16 is overlying silicon-containing CMC substrate 32 without a silicon bond coat. For example, article 10 may be configured to operate in a relatively high temperature environment where a silicon bond coat may not be desirable because of the high temperature.

Silicon-containing CMC substrate 32 may include any CMC substrate that includes silicon as either a matrix or reinforcement phase. For example, silicon-containing CMC substrate 32 may include a silicon carbide (SiC)/SiC substrate, a carbon (C)/SiC substrate, or any other CMC that includes silicon or a silicon compound. In some examples, silicon-containing CMC substrate 32 may include residual silicon.

In some examples, the coating systems may be used with ceramic materials that include one or more silicon-containing layers overlying the ceramic material. FIG. 3 is a conceptual cross-sectional view of an example article that includes a coating system on a silicon-containing ceramic substrate that includes a silicon-containing bond coat 44. In the example of FIG. 3, silicon-containing ceramic substrate 12 includes a ceramic matrix composite (CMC) substrate 42 and silicon-containing bond coat 44 overlying ceramic matrix composite (CMC) substrate 42, such that intermediate coating 16 is overlying bond coat 44. While bond coat 44 is illustrated as being directly on CMC substrate 42, in other examples, one or more coatings or layers of coatings may be between bond coat 14 and substrate 42.

Bond coat 44 may increase the adhesion of coating system 14 to substrate 42. The composition of bond coat 44 may be selected based on the chemical composition and/or phase constitution of substrate 42 and the overlying layers of coating system 14, such that bond coat 44 is compatible with the material from which substrate 42 is formed. Bond coat 44 may include mullite (aluminum silicate, Al₆Si₂O₁₃), silicon metal or alloy, silica, a silicide, or any other material that includes silicon or a silicon-containing compound. Bond coat 14 may further include other elements, such as a rare earth silicate including a silicate of lutetium (Lu), ytterbium (Yb), thulium (Tm), erbium (Er), holmium (Ho), dysprosium (Dy), gadolinium (Gd), terbium (Tb), europium (Eu), samarium (Sm), promethium (Pm), neodymium (Nd), prascodymium (Pr), cerium (Ce), lanthanum (La), yttrium (Y), and/or scandium (Sc). In some examples, bond coat 44 has a thickness of approximately 25 microns to approximately 250 microns, although other thicknesses are contemplated.

In some examples, bond coat 44 includes multiple layers. For example, in some examples in which substrate 42 includes a CMC including silicon carbide, bond coat 44 may include a layer of silicon on substrate 42 and a layer of mullite, a rare earth silicate, or a mullite/rare earth silicate dual layer on the layer of silicon. In some examples, a bond coat 44 including multiple layers may provide multiple functions of bond coat 44, such as, for example, adhesion of substrate 42 to an overlying layer (e.g., barrier coating 18 of FIGS. 1A and 1B), chemical compatibility of bond coat 44 with each of substrate 42 and the overlying layer, a better coefficient of thermal expansion match of adjacent layers, or the like.

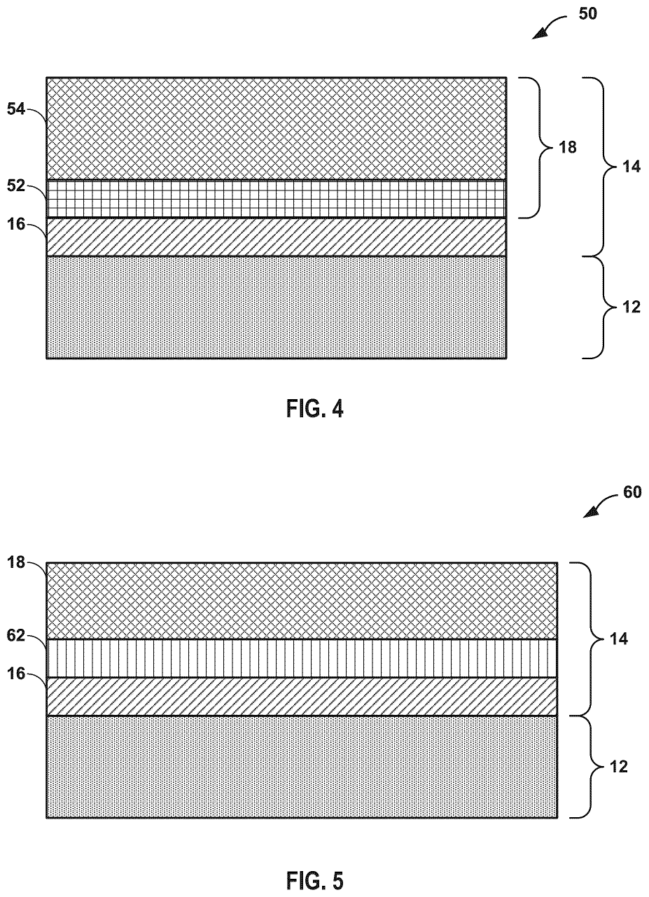

In some examples, barrier coating 18 may include two or more coatings. FIG. 4 is a conceptual cross-sectional view of an example article 50 that includes an example coating system that includes an abradable coating 54 overlying an environmental barrier coating (EBC) 52. EBC 52 may be configured to help protect underlying substrate 12 from chemical species present in the environment in which article 50 is used, such as, e.g., water vapor, Calcium-Magnesium-Alumino-Silicate (CMAS; a contaminant that may be present in intake gases of gas turbine engines), or the like. Abradable coating 54 may be configured such that the outer surface of abradable coating 54 is abraded, e.g., when brought into contact with an opposing surface such as a blade tip.

EBC 52 and/or abradable coating 54 may be any suitable thickness. As one example, EBC 52 may have a thickness of about 0.001 inches (about 25.4 micrometers) to about 0.032 inches (about 813 micrometers). Abradable coating 46 may be about 0.005 inches (about 127 micrometers) to about 0.100 inches (about 2540 micrometers) thick.

EBC 52 and abradable coating 54 may each have a porosity, with a porosity of abradable coating 54 being greater than a porosity of EBC 52. In some examples, EBC 52 has porosity of more than about 1 vol. %, such as about 1 vol. % to about 20 vol. %, where porosity is measured as a percentage of pore volume divided by total volume of EBC 52. In some examples, abradable coating 54 has a porosity of more than about 15 vol. %, such as more than about 25 vol. %, more than 35 vol. %, or about 25 vol. % to about 45 vol. %, where porosity is measured as a percentage of pore volume divided by total volume of abradable coating 54.

In some examples, additional hafnium-containing layers may be deposited as intermediate layers. FIG. 5 is a conceptual cross-sectional view of an example article 60 that includes a coating system 14 that includes more than one intermediate layer on a silicon-containing ceramic substrate 12. In the example of FIG. 5, coating system 14 includes a first intermediate coating 16 as described above, as well as a second intermediate coating 62 overlying intermediate coating 16. Second intermediate coating 62 includes hafnium dioxide. Once article 60 is exposed to a high temperature environment, the hafnium dioxide of second intermediate coating 62 may react with silicon dioxide of intermediate coating 16 to form hafnium silicate. As a result, a thickness of TGO layer 24 may be reduced compared to a coating system that only includes intermediate coating 16. A thickness of second intermediate coating 62 may be selected such that a sufficient amount of hafnium dioxide is available to react with silicon dioxide of TGO layer 24 over the desired period of time.

Second intermediate coating 62 may be present at an initial thickness so that hafnium dioxide is available for the life of article 60. In some examples, second intermediate coating 62 has a thickness between about 25 micrometers and about 300 micrometers.

FIGS. 6A and 6B are flow diagrams illustrating example techniques for forming a coating system on a silicon-containing ceramic substrate. While the example techniques of FIG. 6A and 6B are described with reference to article 10 of FIGS. 1A and 1B, article 30 of FIG. 2, article 40 of FIG. 3, article 50 of FIG. 4, and article 60 of FIG. 5, the example techniques of FIGS. 6A and 6B may be used to prepare any example articles according to the disclosure.

In examples in which silicon-containing ceramic substrate 12 includes a silicon-containing bond coat, such as bond coat 44 of FIG. 3, the example techniques of FIGS. 6A and 6B optionally includes forming the silicon-containing bond coat on an underlying ceramic or CMC substrate (70). The bond coat includes elemental silicon, and may promote bonding or retention of subsequently deposited or applied layers, for example, intermediate coating 16 and/or barrier coating 18, on substrate 12. Forming bond coat 44 on substrate 42 may include, for example, thermal spraying, e.g., air plasma spraying, high velocity oxy-fuel (HVOF) spraying, low vapor plasma spraying, suspension plasma spraying, or low pressure plasma spraying (LPPS); physical vapor deposition (PVD), e.g., electron beam physical vapor deposition (EB-PVD), directed vapor deposition (DVD), cathodic arc deposition; chemical vapor deposition (CVD); slurry process deposition; sol-gel process deposition; electrophoretic deposition; or the like.

The example techniques of FIGS. 6A and 6B include forming intermediate coating 16 on silicon-containing ceramic substrate 12 (72). In examples in which silicon-containing ceramic substrate 12 includes a ceramic or ceramic matrix composite substrate and a silicon-containing bond coat overlying the substrate, such as illustrated in article 40 of FIG. 3, forming intermediate coating 16 on silicon-containing ceramic substrate 12 includes forming intermediate coating 16 on the silicon-containing bond coat. In examples in which silicon-containing ceramic substrate 12 includes a silicon-containing ceramic or ceramic matrix composite (CMC) substrate, such as article 30 of FIG. 2, forming intermediate coating 16 on silicon-containing ceramic substrate 12 includes forming intermediate coating 16 on the silicon-containing ceramic or CMC substrate.

Intermediate coating 16 may be applied on substrate 12 using, for example, thermal spraying, e.g., air plasma spraying, high velocity oxy-fuel (HVOF) spraying, low vapor plasma spraying, suspension plasma spraying; physical vapor deposition (PVD), e.g., electron beam physical vapor deposition (EB-PVD), directed vapor deposition (DVD), cathodic arc deposition; chemical vapor deposition (CVD); slurry process deposition; sol-gel process deposition; electrophoretic deposition; or the like.

In some examples, forming intermediate coating 16 includes controlling deposition of silicon and hafnium disilicide to achieve a desired composition and/or thickness of intermediate coating 16. For example, intermediate coating 16 may be formed using silicon and hafnium disilicide materials in a ratio or at a rate that produced the composition and/or thickness. The composition of intermediate coating 16 may be defined by a bottom limit of hafnium disilicide sufficient to inhibit formation of silicon dioxide and a top limit of hafnium disilicide sufficient to maintain integrity of coating system 14 in response to thermal cycling (e.g., by having a relatively similar CTE).

In some examples, forming intermediate coating 16 includes controlling deposition of silicon and hafnium disilicide to achieve a desired compositional grading of hafnium disilicide in intermediate coating 16. For example, for intermediate coating 16 applied in a layer-by-layer manner, a ratio of silicon to hafnium disilicide materials deposited in a particular layer may be lower near a top portion of intermediate coating 16 than a bottom portion of intermediate coating 16, such that a resulting mol fraction of hafnium disilicide in the top portion is greater than a mol fraction of hafnium disilicide in the bottom portion.

Referring to FIG. 6A, in some examples, the technique of FIG. 6A may include heating intermediate coating 16 to convert at least a portion of the hafnium disilicide to hafnium dioxide and at least a portion of the silicon to silicon dioxide (74). For example, heating intermediate coating 16 may cause at least a portion of the hafnium disilicide to oxidize and form hafnium dioxide and/or cause at least a portion of the silicon to oxidize and form silicon dioxide. Upon exposure to a high temperature environment, the hafnium dioxide and the silicon dioxide of intermediate coating 16 may react to form hafnium silicate. This formation may accelerate subsequent formation of hafnium silicate, such as by making hafnium dioxide available for reaction with silicon dioxide formed as part of TGO layer 24. As a result, a thickness of TGO layer 24 may be reduced compared to an intermediate coating 16 that does not include hafnium dioxide and silicon dioxide prior to exposing article 10 to a high temperature environment. To control an amount of hafnium dioxide and/or silicon dioxide formed from the heat treatment, a temperature, treatment time, and/or treatment environment (e.g., composition of atmosphere) may be selected to provide a desired composition of the hafnium dioxide and/or silicon dioxide in intermediate coating 16.

The example technique of FIG. 6A includes forming barrier coating 18 on intermediate coating 16 (76). Forming barrier coating on intermediate layer 16 may include one or more of vapor deposition (EB-PVD, DVD), chemical vapor deposition (CVD), slurry deposition, sol-gel deposition, tape casting, electrophoretic deposition, or thermal spraying. Thermal spraying may include, e.g., air plasma spraying (APS), suspension plasma spraying (SPS), high velocity oxygen fuel (HVOF) spraying, low pressure plasma spraying (LPPS), very low pressure plasma spraying (VLLPS), and plasma spray-physical vapor deposition (PS-PVD). A slurry may be deposited using painting, dip coating, spraying, or the like, followed by drying and sintering. The slurry particles may include the desired composition of the final coating, and/or may include precursors, such as Si-rich RE disilicate particles and particles of the one or more additional materials, that react during a sintering process to form the coating with a desired composition.

FIG. 6B is a flow diagram illustrating an example technique for forming a coating system on a silicon-containing ceramic substrate that includes forming two intermediate coatings. The technique of FIG. 6B may include forming a bond coat on a ceramic substrate (70). Rather than form a single intermediate layer that includes hafnium disilicate, two different intermediate coatings may be formed to react with silicon dioxide of TGO layer 24 and form hafnium silicate as hafnium silicate coating 26. The example technique of FIG. 6B includes forming first intermediate coating 16 on silicon-containing ceramic substrate 12 (82), similar to step 72 of FIG. 6A. The method further includes forming second intermediate coating 62 on first intermediate coating 16 (84). Second intermediate coating 62 includes hafnium dioxide, which may directly react with silicon dioxide of TGO layer 24. Second intermediate coating 62 may be applied on first intermediate coating 16 using, for example, thermal spraying, e.g., air plasma spraying, high velocity oxy-fuel (HVOF) spraying, low vapor plasma spraying, suspension plasma spraying; physical vapor deposition (PVD), e.g., electron beam physical vapor deposition (EB-PVD), directed vapor deposition (DVD), cathodic arc deposition; chemical vapor deposition (CVD); slurry process deposition; sol-gel process deposition; electrophoretic deposition; or the like. In some examples, forming second intermediate coating 62 includes controlling deposition of hafnium dioxide to achieve a desired thickness of second intermediate coating 62. Second intermediate coating 62 may complement first intermediate coating 16, such that the thickness of second intermediate coating 62 may be defined by a bottom limit of hafnium dioxide sufficient to inhibit formation of silicon dioxide in combination with first intermediate coating 16 and a top limit of hafnium dioxide sufficient to maintain integrity of coating system 14 in response to thermal cycling (e.g., by having a relatively similar CTE). The example technique of FIG. 6B includes forming barrier coating 16 on second intermediate coating 62 (86).

Example 1: An article includes a silicon-containing ceramic substrate; and a coating system overlying the silicon-containing ceramic substrate, wherein the coating system comprises: an intermediate coating overlying the silicon-containing ceramic substrate, wherein the intermediate coating includes silicon (Si) and hafnium disilicide (HfSi₂), and wherein a coefficient of thermal expansion (CTE) of the intermediate coating is less than about 7 parts per million (ppm) per degree Kelvin (K); and a barrier coating overlying the intermediate coating.

Example 2: The article of example 1, wherein the intermediate coating further comprises hafnium dioxide (HfO₂) and silicon dioxide (SiO₂).

Example 3: The article of any of examples 1 and 2, wherein hafnium from the hafnium disilicide is configured to be incorporated into a TGO layer that forms between the intermediate coating and the silicon-containing ceramic substrate and react with silicon dioxide of the TGO layer to form hafnium silicate.

Example 4: The article of any of examples 1 through 3, wherein the silicon-containing ceramic substrate comprises: a ceramic matrix composite (CMC) substrate; and a silicon-containing bond coat overlying the ceramic matrix composite (CMC), and wherein the intermediate coating is overlying the bond coat.

Example 5: The article of any of examples 1 through 4, wherein the wherein the silicon-containing ceramic substrate comprises a silicon-containing ceramic matrix composite (CMC) substrate, and wherein the intermediate coating is overlying the silicon-containing CMC substrate.

Example 6: The article of any of examples 1 through 5, wherein the intermediate coating includes a top portion proximate to the barrier coating and a bottom portion proximate to the silicon-containing ceramic substrate, and wherein a volume fraction of hafnium disilicide in the top portion is greater than a volume fraction of hafnium disilicide in the bottom portion.

Example 7: The article of any of examples 1 through 6, wherein the barrier coating comprises an environmental barrier coating (EBC).

Example 8: The article of example 7, wherein the EBC comprises at least one of a rare earth (RE) disilicate, RE monosilicate, a RE disilicate and RE monosilicate mixture, a RE disilicate and silicon dioxide mixture, mullite, or BSAS.

Example 9: The article of any of examples 1 through 8, wherein the intermediate layer comprising a first intermediate layer, wherein the article further comprises a second intermediate layer overlying the first intermediate layer, and wherein the second intermediate coating includes hafnium dioxide (HfO₂).

Example 10: The article of any of examples 1 through 9, wherein the coating system further comprises an abradable coating overlying the barrier coating.

Example 11: A method of forming a coating system includes forming an intermediate coating on a silicon-containing ceramic substrate, wherein the intermediate coating includes silicon (Si) and hafnium disilicide (HfSi₂), and wherein a coefficient of thermal expansion (CTE) of the intermediate coating is less than about 7 parts per million (ppm) per degree Kelvin (K); and forming a barrier coating on the intermediate coating.

Example 12: The method of example 11, further comprising heating the intermediate coating to convert at least a portion of the hafnium disilicide to hafnium dioxide (HfO₂) and at least a portion of the silicon to silicon dioxide (SiO₂).

Example 13: The method of example 12, wherein the barrier coating is formed on the intermediate coating after heating the intermediate coating.

Example 14: The method of any of examples 11 through 13, wherein hafnium from the hafnium disilicide is configured to be incorporated into a TGO layer that forms between the intermediate coating and the silicon-containing ceramic substrate and react with silicon dioxide of the TGO layer to form hafnium silicate.

Example 15: The method of any of examples 11 through 14, wherein the silicon-containing ceramic substrate comprises: a ceramic matrix composite (CMC) substrate; and a silicon-containing bond coat overlying the CMC substrate, and wherein forming the intermediate coating on the silicon-containing ceramic substrate comprises forming the intermediate coating on the silicon-containing bond coat.

Example 16: The method of any of examples 11 through 15, wherein the silicon-containing ceramic substrate comprises a silicon-containing ceramic matrix composite (CMC) substrate, and wherein forming the intermediate coating on the silicon-containing ceramic substrate comprises forming the intermediate coating on the silicon-containing CMC substrate.

Example 17: The method of any of examples 11 through 16, wherein the intermediate coating includes a top portion proximate to the barrier coating and a bottom portion proximate to the silicon-containing ceramic substrate, and wherein a mol fraction of hafnium disilicide in the top portion is greater than a mol fraction of hafnium disilicide in the bottom portion.

Example 18: The method of any of examples 11 through 17, wherein the barrier coating comprises an environmental barrier coating (EBC).

Example 19: The method of example 18, wherein the EBC comprises at least one of a rare earth (RE) disilicate, RE monosilicate, a RE disilicate and RE monosilicate mixture, a RE disilicate and silicon dioxide mixture, mullite, or BSAS.

Example 20: The method of any of examples 11 through 19, wherein the intermediate coating comprises a first intermediate coating, wherein the method further comprises forming a second intermediate coating overlying the first intermediate coating, and wherein the second intermediate coating includes hafnium dioxide (HfO₂).

Various examples have been described. These and other examples are within the scope of the following clauses and claims.

What is claimed is:

1. An article comprising:
a silicon-containing ceramic substrate; and
a coating system overlying the silicon-containing ceramic substrate, wherein the coating system comprises:
an intermediate coating overlying the silicon-containing ceramic substrate, wherein the intermediate coating includes silicon (Si) and hafnium disilicide (HfSi₂), and wherein a coefficient of thermal expansion (CTE) of the intermediate coating is less than about 7 parts per million (ppm) per degree Kelvin (K); and
a barrier coating overlying the intermediate coating.

2. The article of claim 1, wherein the intermediate coating further comprises hafnium dioxide (HfO₂) and silicon dioxide (SiO₂).

3. The article of claim 1, wherein hafnium from the hafnium disilicide is configured to be incorporated into a TGO layer that forms between the intermediate coating and the silicon-containing ceramic substrate and react with silicon dioxide of the TGO layer to form hafnium silicate (HfSiO₄).

4. The article of claim 1,
wherein the silicon-containing ceramic substrate comprises:
a ceramic matrix composite (CMC) substrate; and
a silicon-containing bond coat overlying the ceramic matrix composite (CMC), and
wherein the intermediate coating is overlying the bond coat.

5. The article of claim 1,
wherein the silicon-containing ceramic substrate comprises a silicon-containing ceramic matrix composite (CMC) substrate, and
wherein the intermediate coating is overlying the silicon-containing CMC substrate.

6. The article of claim 1,
wherein the intermediate coating includes a top portion proximate to the barrier coating and a bottom portion proximate to the silicon-containing ceramic substrate, and wherein a volume fraction of hafnium disilicide in the top portion is greater than a volume fraction of hafnium disilicide in the bottom portion.

7. The article of claim 1, wherein the barrier coating comprises an environmental barrier coating (EBC).

8. The article of claim 7, wherein the EBC comprises at least one of a rare earth (RE) disilicate, RE monosilicate, a RE disilicate and RE monosilicate mixture, a RE disilicate and silicon dioxide mixture, mullite, or BSAS.

9. The article of claim 1,
wherein the intermediate layer comprising a first intermediate layer,
wherein the article further comprises a second intermediate layer overlying the first intermediate layer, and
wherein the second intermediate coating includes hafnium dioxide (HfO₂).

10. The article of claim 1, wherein the coating system further comprises an abradable coating overlying the barrier coating.

11. A method of forming a coating system, comprising:
forming an intermediate coating on a silicon-containing ceramic substrate, wherein the intermediate coating includes silicon (Si) and hafnium disilicide (HfSi₂), and wherein a coefficient of thermal expansion (CTE) of the intermediate coating is less than about 7 parts per million (ppm) per degree Kelvin (K); and
forming a barrier coating on the intermediate coating.

12. The method of claim 11, further comprising heating the intermediate coating to convert at least a portion of the hafnium disilicide to hafnium dioxide (HfO₂) and at least a portion of the silicon to silicon dioxide (SiO₂).

13. The method of claim 12, wherein the barrier coating is formed on the intermediate coating after heating the intermediate coating.

14. The method of claim 11, wherein hafnium from the hafnium disilicide is configured to be incorporated into a TGO layer that forms between the intermediate coating and the silicon-containing ceramic substrate and react with silicon dioxide of the TGO layer to form hafnium silicate (HfSiO₄).

15. The method of claim 11,
wherein the silicon-containing ceramic substrate comprises:
a ceramic matrix composite (CMC) substrate; and
a silicon-containing bond coat overlying the CMC substrate, and
wherein forming the intermediate coating on the silicon-containing ceramic substrate comprises forming the intermediate coating on the silicon-containing bond coat.

16. The method of claim 11,
wherein the silicon-containing ceramic substrate comprises a silicon-containing ceramic matrix composite (CMC) substrate, and
wherein forming the intermediate coating on the silicon-containing ceramic substrate comprises forming the intermediate coating on the silicon-containing CMC substrate.

17. The method of claim 11,
wherein the intermediate coating includes a top portion proximate to the barrier coating and a bottom portion proximate to the silicon-containing ceramic substrate, and
wherein a mol fraction of hafnium disilicide in the top portion is greater than a mol fraction of hafnium disilicide in the bottom portion.

18. The method of claim 11, wherein the barrier coating comprises an environmental barrier coating (EBC).

19. The method of claim 18, wherein the EBC comprises at least one of a rare earth (RE) disilicate, RE monosilicate, a RE disilicate and RE monosilicate mixture, a RE disilicate and silicon dioxide mixture, mullite, or BSAS.

20. The method of claim 11,
wherein the intermediate coating comprises a first intermediate coating,
wherein the method further comprises forming a second intermediate coating overlying the first intermediate coating, and
wherein the second intermediate coating includes hafnium dioxide (HfO₂).
